(19) United States
(12) Patent Application Publication
(10) Pub. No.: US 2026/0261775 A1
(43) Pub. Date: Sep. 3, 2026

(54) METHOD FOR DETERMINING CALIBRATION INFORMATION AND GENERATING IMAGES FOR AN IMAGE SENSOR AND ASSOCIATED IMAGE SENSOR

(71) Applicant: BERTIN TECHNOLOGIES, Montigny-le-Bretonneux (FR)

(72) Inventors: David ORIOT, Saint-Chamas (FR); Emmanuel SOULIÉ, Rousset (FR); Damien DIAZ, Cabriès (FR)

(73) Assignee: BERTIN TECHNOLOGIES, Montigny-le-Bretonneux (FR)

(21) Appl. No.: 18/878,566

(22) PCT Filed: Jun. 15, 2023
(86) PCT No.: PCT/EP2023/066079

§ 371 Date: Dec. 23, 2024

(30) Foreign Application Priority Data
Jun. 23, 2022 (FR) 2206236

(51) Int. Cl. H04N 25/671; H04N 23/52

(52) U.S. Cl. CPC H04N 25/671; H04N 23/52

(57) ABSTRACT

A method for determining calibration information for an image sensor comprising a plurality of pixels, the method comprising: obtaining (S1) at least two calibration tables (10 to 13) associated with the image sensor, each calibration table (10 to 13) containing, for each pixel, a piece of calibration information, the calibration information of the calibration table (10 to 13) being organized into a series ordered according to a successive order of the pixels (OP), and constructing (S2) at least one correction table (20, 21) for the image sensor, each correction table (20, 21) containing the calibration information of at least two calibration tables (10 to 13), the calibration information of the correction table (20, 21) being organized into a series ordered according to the successive order of the pixels (OP).

### TECHNICAL FIELD

The present invention relates to image sensors comprising a plurality of pixels, and more particularly infrared sensors. The invention also relates to methods for determining calibration information and generating images for such image sensors.

### PRIOR ART

Currently, image sensors are used in various and varied technical fields. For example, image sensors may be integrated into smartphones. In this case, it is interesting to provide sensors that consume as little electrical energy as possible in order to preserve the greatest possible operating autonomy of the telephone. In other fields, it is possible to use infrared-type sensors, i.e. sensors that are sensitive to infrared radiations, in particular to visualize scenes in the dark. Such infrared sensors may be integrated into portable binoculars and it is also interesting to provide low-power sensors in order to limit the weight of the batteries of such binoculars.

In general, the sensors are provided with photosensitive receivers configured to convert an electromagnetic radiation into an analog electrical signal intended to generate a digital image, i.e. an image comprising a plurality of pixels, based on analog electrical signals. One of the main problems of these receivers is a thermal drift of the receivers. This problem concerns infrared sensors more particularly. Thus, this drift implies performing a calibration of the sensors in order to obtain a digital image that is as close as possible to reality.

Mention may be made of the American patent application US2007029484 which discloses a read-out circuit for an array of microbolometric detectors using a temperature sensor so as to compensate the measurements of the detector for the temperature-induced errors in the reading of the array of microbolometers. The document discloses a use of a memory which could contain a “pixel map”, i.e. which would contain the desired state of a selection switch for each microbolometer of the array. Yet, these read-out circuits are complex, besides, they use selection switches whose controls consume electrical energy.

Mention may also be made of French patent application FR3107116, which discloses a method for calibrating a bolometer-type optoelectronic device, wherein the device is placed in a climatic chamber, the temperature inside the climatic chamber is modified, the bias voltage of each bolometer is recorded and, for each bolometer, a correction electrical voltage value is recorded according to the temperature. The values are recorded in tables. Yet, this method requires the creation of numerous tables of values the reading of which also consume electrical energy, in particular when it is desired to use the optoelectronic device to carry out video acquisition.

Mention may also be made of American patent application U.S. Pat. No. 8,378,290 which discloses a calibration method for an infrared camera, wherein correction data determined during a calibration procedure are recorded. The calibration information is recorded in a digital file loaded into the memory of the camera. Yet, access to the correction data stored in a digital file also consumes electrical energy.

An object of the invention consists in overcoming these drawbacks, and more particularly providing means for generating digital images whose quality is improved, while consuming as little electrical energy as possible.

### SUMMARY

To achieve this objective, a method is provided for determining calibration information for an image sensor comprising a plurality of pixels, the method comprising obtaining at least two calibration tables associated with the image sensor, each calibration table containing, for each pixel, a piece of calibration information, the calibration information of the calibration table being organized into a series ordered according to a successive order of the pixels.

The method comprises constructing at least one correction table for the image sensor, each correction table containing the calibration information of at least two calibration tables, the calibration information of the correction table is organized into a series ordered according to the successive order of the pixels.

Thus, correction tables containing calibration information adapted to limit accesses to the information contained thereon are provided. Thus, when it is desired to use these correction tables, in particular to correct a temperature drift of an image sensor, the electrical consumption of the sensor is limited. These correction tables are particularly suitable for use within mobile compact appliances, in particular appliances using batteries, such as binoculars or smartphones.

A method is also provided for generating images comprising a plurality of pixels, the method comprising: recording in at least one memory of an image sensor at least one correction table for the image sensor constructed by the method as defined hereinbefore; successively acquiring, according to a successive order of the pixels, the image frame data generated by the image sensor; accessing said at least one memory comprising reading the calibration information contained in said at least one correction table; and successively applying, according to the successive order of the pixels, the calibration information contained in said at least one correction table to the image frame data.

Such a method allows improving the quality of the images provided by an image sensor, while limiting the electrical consumption of the sensor.

An image sensor is also provided comprising a plurality of pixels, the sensor comprising at least one memory containing at least one correction table for the image sensor.

said at least one correction table is constructed by the method for determining calibration information as defined hereinbefore.

According to another aspect of the invention, a computer program product is provided intended for determining calibration information, comprising instructions which, when executed by an electronic control unit, enable the electronic control unit to perform the steps of the method for determining calibration information as defined hereinbefore.

A computer program product is also provided intended for generating images comprising a plurality of pixels, comprising instructions which, when executed by an electronic control unit, enable the electronic control unit to perform the steps of the method for generating images as defined hereinbefore.

### BRIEF DESCRIPTION OF THE FIGURES

The aims, objects, as well as the features and advantages of the invention will appear more clearly from the detailed description of embodiments and implementations of the latter, illustrated by the following appended drawings, wherein:

FIG. 1 schematically illustrates an embodiment of an image sensor;

FIG. 2 schematically illustrates the main steps of a calibration phase of an image sensor;

FIG. 3 schematically illustrates the main steps of an implementation of a method for generating images; and

FIG. 4 schematically illustrates the main steps of an implementation of a method for determining calibration information.

The drawings are given as examples and do not limit the invention. They are schematic representations of principle intended to facilitate understanding of the invention and are not necessarily plotted to the scale of practical applications.

### DETAILED DESCRIPTION

Before beginning a detailed review of embodiments and implementations of the invention, optional features are set out hereinafter, which could possibly be used in combination or alternatively.

According to one example:
The construction of each correction table comprises interleaving the calibration information of said at least two calibration tables so that the calibration information of the correction table is organized, for each pixel, according to a successive order of the calibration tables.
The calibration information of at least one calibration table, so-called calibration table at a specific temperature, comprise non-uniformity correction parameters of the image sensor at the specific temperature.
The obtainment comprises obtaining several calibration tables, so-called calibration tables at distinct specific temperatures, and the construction comprises constructing at least one correction table containing the calibration information of at least two calibration tables at distinct specific temperatures.
The obtainment comprises obtaining at least three calibration tables, so-called calibration tables at three distinct specific temperatures, and the construction comprises constructing at least one correction table containing the calibration information of said at least three calibration tables at distinct specific temperatures.
The obtainment comprises obtaining at least three calibration tables, so-called calibration tables at three distinct specific temperatures, and the construction comprises constructing a first correction table containing the calibration information of first and second calibration tables at two successive temperatures according to the successive order of the calibration tables, and a second correction table containing the calibration information of the second and third calibration tables at a specific temperature successive to that of the second calibration table according to the successive order of the calibration tables.
The calibration information of a calibration table, so-called gain table, comprise calibration gains.
The construction comprises constructing at least two correction tables, each correction table containing the calibration information of the gain table.
The acquisition is performed on-the-fly, i.e. without recording the image frame data.
The read-out is performed on-the-fly, i.e. without recording the calibration information.
The acquisition and the read-out are performed, for each pixel, synchronously.
Said at least one correction table is constructed by the method for determining calibration information as defined hereinbefore, said at least one correction table comprises non-uniformity correction parameters of the image sensor at least at two distinct specific temperatures, the method comprising recording in said at least one memory a list of correspondence between said at least one correction table and at least one temperature interval having as lower and upper bounds respectively said at least two distinct specific temperatures, and wherein the acquisition comprises reading a temperature of the image sensor, and the accessing comprises reading the calibration information contained in the correction table for which the temperature of the image sensor is comprised within the corresponding temperature interval of the correction table.
The method for generating images comprises, after the access and before the application, demultiplexing the calibration information for each pixel.
The sensor comprises a first memory comprising at least one correction table containing non-uniformity correction parameters of the image sensor at least at a specific temperature and a second memory comprising a gain table containing, for each pixel, calibration gains organized into a series ordered according to a successive order of the pixels.
Said at least one memory is a non-volatile memory configured for read-only operation.
The sensor comprises an electronic control unit configured to implement the method for generating images as defined hereinbefore.
The electronic control unit comprises an FPGA-type programmable logic circuit, i.e. an array of programmable logic gates.

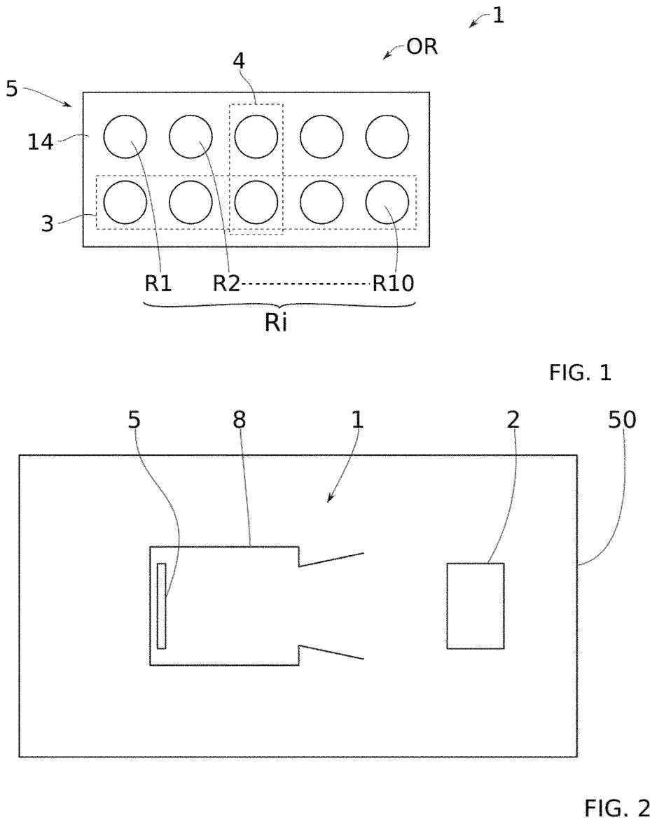

FIGS. 1 to 3 show an image sensor 1. The sensor 1 is configured to provide a digital image, in other words an image comprising a plurality of pixels. Each of the images comprises the same number of pixels, and the pixels are ordered in an image in columns and in rows in the form of an array of pixels. Moreover, the sensor 1 comprises a plurality of photosensitive receivers Ri (i being an integer used to refer to a receiver), typically bolometers, arranged in rows 3 and in columns 4, and form an array of receivers 5. The sensor 1 comprises a case 8 within which the array of the 10 receivers 5 is accommodated. For simplicity, and for example, an array 5 comprising ten receivers R1 to R10 (i being comprised between 1 and 10) has been shown. It is also said that the receivers Ri are ordered in the array 5, according to a successive order of the receivers OR. Each photosensitive receiver Ri is configured to convert an electromagnetic radiation into an analog electrical signal intended to generate a digital image. Thus, the value of a pixel of an image corresponds to the value of the analog electrical signal originating from a photosensitive receiver Ri. Advantageously, the image sensor 1 may comprise an apparatus 14 for measuring the temperature of the image sensor 1.

It turns out that the photosensitive receivers Ri feature a non-uniformity according to the temperature. In other words, there is a temperature drift of the sensor 1. This means that, for a determined temperature of the sensor 1, and when the sensor 1 receives an electromagnetic radiation originating from a homogeneous object, in particular a black body 2, the photosensitive receivers Ri do not all generate the same analog electrical signals. By black body 2, it should be understood an element or a device whose temperature is estimated to be stable and wherein the emissivity ε of its surface is close to 1, more particularly strictly higher than 0.97. The emissivity ε of a material is the ratio between the amount of energy emitted by its surface and the energy emitted by a black body 2 brought to the same temperature. Hence, the emissivity is unitless and comprised between 0 and 1 (1 being the value for a perfect black body).

In order to correct the temperature drift of the photosensitive receivers Ri, calibration information is used.

FIG. 4 shows the main steps of a method for determining calibration information for an image sensor 1 comprising a plurality of pixels.

In general, the method comprises obtaining S1 at least two calibration tables 10 to 13, and constructing S2 at least one correction table 20, 21 for the image sensor 1.

The calibration tables 10 to 13 are associated with the image sensor 1, i.e. they contain calibration information obtained beforehand during a calibration phase of the image sensor 1. An example of a calibration phase will be described later on. In particular, each calibration table 10 to 13 contains a piece of calibration information for each pixel. FIG. 1 shows, for example, an image sensor 1 comprising ten photosensitive receivers Ri. In this case, each calibration table 10 to 13 contains at least ten calibration information, i.e. at least one piece of calibration information per pixel. For example, a piece of calibration information may comprise a non-uniformity correction parameter PCi(Tj) of the image sensor 1 at a specific temperature Tj (i being the integer used to refer to a receiver and j is an integer to refer to a temperature). In the example illustrated in FIG. 4, three specific temperatures T1 to T3 have been shown, j being comprised between 1 and 3. Such a correction parameter PCi(Tj) allows correcting the electrical signal generated by a receiver Ri, when the sensor 1 is at a specific temperature T1 to T3. In other words, the correction parameters PCi(Tj) depend on a specific temperature T1 to T3. A calibration table 10 to 12 containing correction parameters PCi(Tj) is also called calibration table at a specific temperature T1 to T3. In other words, a calibration table at the specific temperature T1 contains non-uniformity correction parameters PCi(T1) of the image sensor 1 at the specific temperature T1. According to another example, a piece of calibration information may comprise a calibration gain GPi (i being the integer used to refer to a receiver). Unlike the correction parameters PCi(Tj), a calibration gain GPi does not depend on the temperature. This means that a calibration gain GPi allows correcting an electrical signal generated by a receiver Ri irrespective of the temperature of the sensor 1. Moreover, the calibration table 13 containing calibration gains is also so-called gain table. In FIG. 4, the gain table 13 comprises ten calibration gains GP1 to GP10.

In particular, for each calibration table 10 to 13, the calibration information is organized into a series ordered according to a successive order of the pixels OP. In particular, all of the calibration tables 10 to 13 contain calibration information ordered in the same manner. Preferably, the successive order of the pixels OP in an image is identical to the successive order of the receivers OR of the sensor 1. In other words, the first calibration information of each of the calibration tables 10 to 13 allows correcting the analog electrical signal generated by the first receiver R1 of the array of receivers 5. Furthermore, the second calibration information of each of the calibration tables 10 to 13 allows correcting the analog electrical signal generated by the second receiver R2 of the array of receivers 5, and so on. The calibration information is associated with the receiver Ri of the sensor 1, and it is said that the calibration tables 10 to 13 are associated with the sensor 1.

The calibration tables 10 to 13 may be obtained during a calibration phase. FIG. 2 shows the possible main steps of the calibration phase. The calibration phase comprises placing the image sensor 1 in a climatic chamber 50. The climatic chamber 50 comprises a black body 2 placed opposite the image sensor 1. Moreover, the calibration phase comprises modifying the temperature inside the climate chamber 50 to reach a first temperature T1, then waiting for a stabilization time so that the temperature of the image sensor 1 is constant, preferably equal to T1. Then, the image sensor 1 generates an analog electrical signal, based on each of the photosensitive receivers Ri, in order to provide values according to the temperature T1. For example, these values may correspond to the non-uniformity correction parameters of the image sensor at the specific temperature T1. In general, a correction parameter PCi(Tj) is determined according to the value of the analog electrical signal generated by the receiver Ri at a specific temperature Tj. Then, the correction parameters PCi(T1) are recorded at the specific temperature T1 in the calibration table 10 at the temperature T1. Furthermore, the calibration phase comprises modifying the temperature inside the climatic chamber 50 to reach a second temperature T2 different from T1, preferably higher than T1, then repeating the waiting and recording steps in order to obtain non-uniformity correction parameters PCi(Tj) of the image sensor at other specific temperatures T2, T3. Thus, the non-uniformity correction parameters PCi(T2) are recorded at a second specific temperature T2, in the calibration table 11 at the temperature T2 and the non-uniformity correction parameters PCi(T3) are recorded at the third specific temperature T3 in the calibration table 12 at the temperature T3.

Advantageously, the calibration phase comprises comparing the values of the analog electrical signals generated at a specific temperature T1 to T3, in order to determine the calibration gain GPi, for each photosensitive receiver Ri. Then, the determined gains are recorded in the gain table 13. It should be noted that the value of the gains does not depend on the temperature.

The construction S2 of at least one correction table 20, 21 is intended to improve access to the calibration information, in terms of speed and amount of consumed electrical energy.

More particularly, the construction S2 of at least one correction table 20, 21 is performed as follows: each correction table 20, 21 contains the calibration information of at least two calibration tables 10 to 13. Thus, a correction table 20, 21 may contain correction parameters PCi(Tj) originating from two calibration tables 10 to 12 respectively associated with two distinct specific temperatures T1 to T3. According to another example, a correction table 20, 21 may contain calibration gains GPi and correction parameters PCi(Tj). In particular, each correction table 20, 21 corresponds to a list of calibration information ordered according to a column. This facilitates access to the information contained therein. It is also said that the correction tables 20, 21 have one single read input. In general, the calibration information of each correction table 20, 21 is organized into a series ordered according to the successive order of the pixels OP. This means that the first calibration information of each correction table 20, 21 is associated with the first pixel of an image, or with the first receiver R1 of the sensor 1. The second calibration information of each of the correction tables 20, 21, which follow the first information, is associated with the second pixel of the image, or with the second receiver R2 of the sensor 1, and so on.

Such an ordering of the calibration information in the correction tables 20, 21 allows facilitating access to the information of these correction tables 20, 21, and thus limit the amount of electrical energy consumed to read the information. Indeed, if it is desired to access the calibration information from the calibration tables 10 to 13, at least two accesses will be necessary if one wishes to access the information of two calibration tables 10 to 13. On the contrary, by using a correction table 20, 21, only one access is necessary to read the information originating from two calibration tables 10 to 13.

Preferably, the construction S2 of at least one correction table 20, 21 comprises interleaving the calibration information of at least two calibration tables 10 to 13 so that the calibration information of the correction table 20, 21 is organized, for each pixel, according to a successive order of the calibration tables OC1, OC2. It is also said that the calibration information is interleaved, or multiplexed, and it is also said that the correction tables 20, 21 are multiplexed. The successive orders of the calibration tables OC1, OC2 are determined beforehand. In particular, a successive order of the calibration tables OC1, OC2 is repeated, for each pixel, periodically for the same correction table 20, 21. According to the example illustrated in FIG. 4, two correction tables 20, 21 are constructed S2. Prior to the construction S2, three calibration tables 10 to 12 at three specific temperatures T1 to T3 and a fourth gain table 13 are obtained. In this example, a first successive order of the first calibration table OC1 may be the first table 10, the second table 11, and the fourth gain table 13. A second successive order of the second calibration table OC2, may be the second table 11, the third table 12 and the fourth gain table 13. It could be noted that, for each pixel, the calibration information of each correction table 20, 21 are ordered according to the same successive order of the calibration tables OC1, OC2. Preferably, the successive orders of the calibration tables OC1, OC2 follow the successive order of the temperatures T1 to T3.

There are several variants for constructing the correction tables 20, 21.

For example, it is possible to construct a correction table 20, 21 based on at least two calibration tables at two distinct specific temperatures T1 to T3. In this case, the construction S2 comprises constructing at least one correction table 20, 21 containing the calibration information of at least two calibration tables at distinct specific temperatures T1 to T3.

It is also possible to construct the same correction table 20, 21 based on at least three calibration tables 10 to 12 at specific temperatures T1 to T3. In this case, the construction S2 comprises constructing at least one correction table 20, 21 containing the calibration information of said at least three calibration tables 10 to 12 at distinct specific temperatures T1 to T3.

Advantageously, it is possible to construct several correction tables 20, 21 based on at least three calibration tables 10 to 12 at three distinct specific temperatures T1 to T3, so that each correction table 20, 21 is constructed based on two calibration tables 10 to 12, while changing calibration tables 10 to 12 for each correction table 20, 21. In this case, the construction S2 comprises constructing a first correction table 20 containing the calibration information of first and second calibration tables 10, 11 at two successive temperatures T1, T2 according to a first successive order of the calibration tables OC1, and a second correction table 21 containing the calibration information based on the second calibration table 11 and a third calibration table 12 at the third specific temperature T3 successive to that of the second calibration table 12 according to a second successive order of the calibration tables OC2.

According to another advantage, it is possible to construct several correction tables 20, 21 based on the same gain table 13. In this case, the construction S2 comprises constructing at least two correction tables 20, 21, each correction table 20, 21 containing the calibration information of the gain table 13. In this case, the gains are found in the two correction tables 20, 21, and intentionally consist of redundant values. Thus, the size of the correction tables 20, 21 is intentionally increased, but the number of accesses to the correction tables remains limited to the number of correction tables 20, 21, which limits the amount of electrical energy to access the information.

FIG. 4 shows an example of construction of correction tables 20, 21 based on three calibration tables 10 to 12 at three distinct temperatures T1 to T3 and based on a gain table 13. For example, the temperatures are consecutive, and T1 is equal to 5° C., T2 is equal to 10° C. and T3 is equal to 15° C.

The method for determining calibration information may further comprise recording S3 the correction tables 20, 21 in a memory 6. Preferably, the memory 6 is a non-volatile memory configured for read-only operation. A non-volatile memory can keep its recorded data even when it is no longer electrically powered. For example, the memory 6 is a flash-type memory. The flash memories are non-volatile memories configured for read-only operation which are also fast in reading and erasable in complete sectors. Moreover, a flash memory enables a modification of several memory spaces in one single operation. A flash memory enables a data read access faster than the data write access.

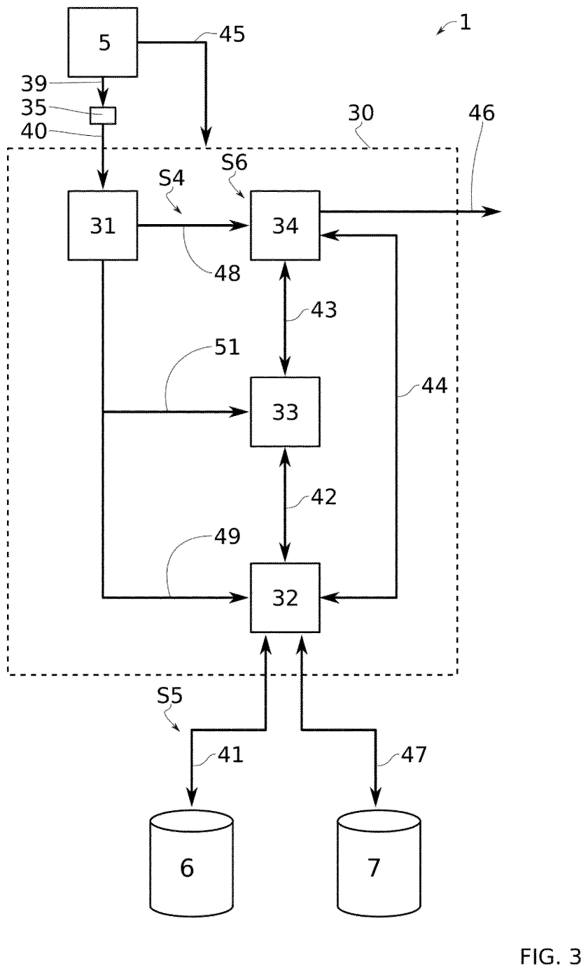

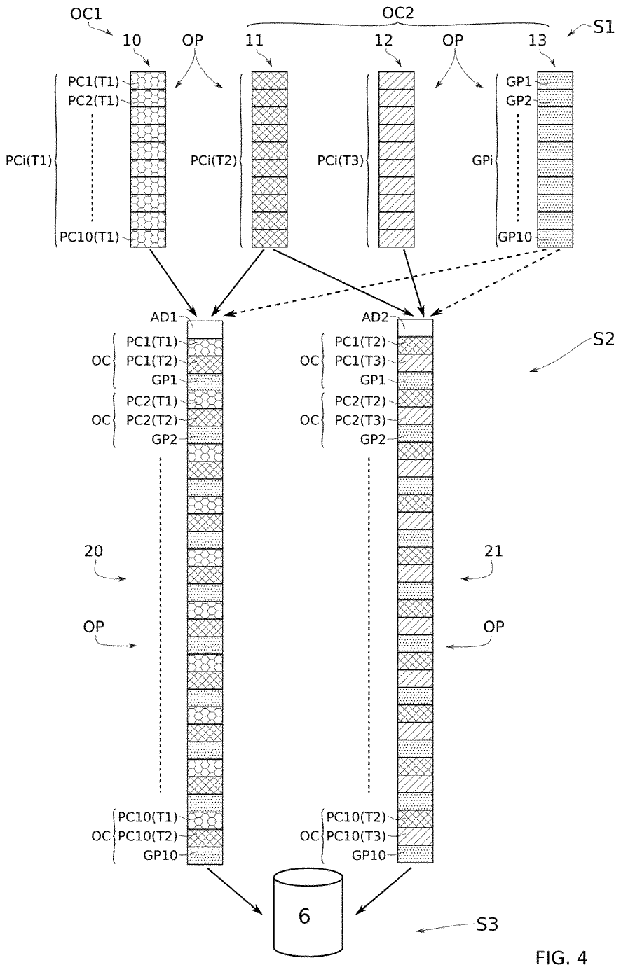

FIG. 3 shows the main steps of an implementation of a method for generating images. The image sensor 1 has also been shown comprising the array of photosensitive receivers 5, an electronic control unit 30 and the memory 6. The electronic control unit 30 is configured to implement the method for generating images. The electronic control unit 30 may comprise an FPGA-type programmable logic circuit, i.e. an array of programmable logic gates. In general, the image sensor 1 comprises an analog-to-digital converter 35 coupled to the photosensitive receivers Ri, via a first connection 39, and configured to digitize the analog electrical signals generated by the photosensitive receivers Ri. In other words, the converter 35 transforms the analog electrical signals into digital signals. The converter 35 may be integrated within the electronic control unit 30, or alternatively it may be integrated within the array of photosensitive receivers 5. More particularly, the converter 35 is configured to transmit, via a second connection 40, the values of the digital electrical signals in the form of an image frame. In general, the data of an image frame contain the values of the digital electrical signals, typically values corresponding to the voltages originating from the photosensitive receivers Ri. The data of an image frame are intended to form the image. Each pixel of an image is generated based on the value of a piece of data of an image frame. In particular, the values of the data of an image frame depend on a temperature of the image sensor 1. Moreover, the data of the image frame are ordered according to an order corresponding to the successive order of the pixels OP. Thus, the first piece of data of the image frame corresponds to the value of the electrical signal supplied by the first photosensitive receiver R1 of the array of the receivers 5.

More particularly, the electronic control unit 30 comprises a first circuit 31 for receiving image frames, coupled to the converter 35 via the second connection 40, and a second processing circuit 32, coupled to the memory 6 via a third connection 41 and configured to perform processing operations on the data originating from the memory 6.

Advantageously, the electronic control unit 30 may comprise a third calculation circuit 33, coupled to the second circuit 32 via a fourth connection 42, and configured to perform calculation operations on the data received from the second circuit 32. Moreover, the electronic control unit 30 may also comprise a fourth correction circuit 34, coupled to the second and third circuits 32, 33 respectively via fifth and sixth connections 43, 44. The fourth circuit 34 allows correcting the value of the image frame data by applying to these values, the calibration information originating from the correction tables 20, 21 recorded in the memory 6. Moreover, the fourth correction circuit 34 is coupled to the first reception circuit 31, via a seventh connection 48, to receive the image frames transmitted by the first acquisition circuit 31. Furthermore, the fourth circuit 34 is configured to provide a corrected image, via an eighth connection 46 corresponding to an output of the electronic control unit 30.

In general, the method for generating images comprises recording S3 the correction tables 20, 21 in the memory 6, acquiring S4 the image frame data, accessing S5 the memory 6 and applying S6 the calibration information.

The correction tables 20, 21, recorded in the memory 6, correspond to the correction tables 20, 21 constructed by the determination method as defined hereinbefore. For example, the correction tables 20, 21 contain non-uniformity correction parameters of the image sensor 1 and are recorded in a first memory 6 and the gain tables 13 may be recorded, either in the first memory 6, or in a distinct second memory 7. Preferably, the second memory 7 is of the same type as the first memory 6. The second memory 7 is coupled to the second processing circuit 32, via a ninth connection 47. The acquisition S4 comprises successively acquiring, according to the successive order of the pixels, image frame data generated by the converter 35. In particular, the first circuit 31 receives the image frame data and transmits them to the fourth circuit 34, via the seventh connection 48. Furthermore, the access S5 to the memory 6 comprises reading the calibration information contained in the correction table(s) 20, 21. The application S6 comprises successively applying, according to the successive order of the pixels OP, the calibration information contained in the correction table(s) 20, 21 to the image frame data.

Preferably, the acquisition S4, and the application S6 are performed for each pixel and in the successive order of the pixels OP. This means that, for each pixel, the electronic control unit 30, and more particularly the fourth circuit 34, acquires a piece of data of the image frame, and more particularly the piece of data associated with the pixel, and applies, to the acquired piece of data, the calibration information contained in the correction table 20, 21 associated with the pixel.

Advantageously, the acquisition S4 is performed on-the-fly, i.e. without recording the image frame data. According to another advantage, reading the calibration information, i.e. reading a correction table 20, 21, is performed on-the-fly, i.e. without recording the calibration information. More particularly, reading a correction table 20, 21 is performed based on an access to the correction table 20, 21 from a specific address AD1, AD2 of the correction table 20, 21. Thus, reading the calibration information is performed based on one single access to a specific address of a correction table 20, 21.

Preferably, the acquisition S4 and the read-out are performed, for each pixel, synchronously. In this case, the circuits 31 to 34 are synchronized with the array of the receivers 5, and more particularly with the converter 35. For example, the electronic control unit 30 is coupled to the array of the receivers 5, via a tenth connection 45, to receive a clock signal allowing synchronizing the circuits 31 to 34. Furthermore, the converter 35 can receive the clock signal, via the first connection 39, in order to be synchronized with the circuits 31 to 34. Thus, the speed of the calculation operations is improved, for each pixel, and therefore the speed of the method for generating images.

Preferably, each correction table 20, 21 comprises parameters for correcting the non-uniformity of the image sensor at least at two distinct specific temperatures T1 to T3. For example, a first correction table 20 containing the correction parameters PCi(T1) and PCi(T2) and a second correction table 21 containing the parameters PCi(T2) and PCi(T3). For example, T1 is equal to 5° C., T2 is equal to 10° C. and T3 is equal to 15° C. Furthermore, the acquisition S4 comprises reading a temperature TC of the image sensor 1, for example via the first reception circuit 31, in order to know the temperature TC of the sensor 1 at which the electrical signals have been generated by the photosensitive receivers Ri. Advantageously, the first reception circuit 31 may transmit the temperature TC of the sensor 1, to the second processing circuit 32, via an eleventh connection 49, and to the third calculation circuit 33, via a twelfth connection 51. The knowledge of such a temperature TC is used by the electronic control unit 30 to select the correction table 20, 21 allowing modifying the value of the electrical signals in order to provide a corrected image. For example, the temperature TC of the sensor 1 may be transmitted to the electronic control unit 30, and in particular to the first reception circuit 31, by the image frames. In other words, a specific data of an image frame comprises the temperature TC of the sensor 1.

Preferably, the temperature TC read by the first receiving circuit 31 of the electronic control unit 30 is used to correct the data of the image frame that follows the preceding frame containing the information on the temperature TC of the sensor 1.

For example, it is possible to correct the value of the image frame data, according to the temperature TC, based on the correction parameters PCi(Tj). The fourth circuit 34 is configured to perform the following calculation for each pixel:

$$Vpixel = Vdata + Vcor \qquad ( equation 1 )$$

Vpixel corresponds to the value of a pixel of the image (unitless);
Vdata corresponds to the value of the image frame data corresponding to the pixel of the image (unitless); and
Vcor corresponds to a correction value (unitless) associated with the pixel of the image.

The correction value Vcor may correspond to the value of a correction parameter PCi(Tj). Preferably, the third circuit 33 is configured to perform an interpolation from a correction table 20, 21, for example by calculating the correction value Vcor=(PCi(T1)+PCi(T2))/2. According to another example, the third circuit 33 may be configured to perform an interpolation by calculating the correction value Vcor=[(T2−TC)/(T2−T1)]×PCi(T1)+[(TC−T1)/(T2−T1)]×PCi(T2); with T2>T1, and TC comprised between T1 and T2.

Advantageously, the fourth circuit 34 is configured to correct in gain of the value of the image frame data, based on the calibration gains GPi. The fourth circuit 34 may be configured to perform the following calculation for each pixel:

$$Vpixel = GPi \times ( Vdata ) . \qquad ( equation 2 )$$

Alternatively, the fourth circuit 34 may be configured to perform the following calculation for each pixel:

$$Vpixel = GPi \times ( Vdata + Vcor ) . \qquad ( equation 3 )$$

Advantageously, the method for generating images comprises, after the access S4 and before the application S6, demultiplexing the calibration information for each pixel.

The second circuit 32 is configured to read the calibration information contained in the correction tables 20, 21. In particular, the second circuit 32 transmits the correction parameters PCi(Tj) to the third circuit 33, when it is desired to perform an interpolation of the data. Alternatively, the second circuit 32 transmits the correction parameters PCi(Tj) to the fourth circuit 34 to calculate the value of the pixel Vpixel without interpolation. When the correction tables 20, 21 contain calibration gains GPi, the second circuit 32 transmits the calibration gains GPi to the fourth circuit 34 to calculate the value of the pixel Vpixel according to the equation 2 or 3.

Advantageously, when it is desired to perform an interpolation, the third circuit 33 transmits, for each pixel, the correction value Vcor to the fourth circuit 34. The fourth circuit 34 calculates the value of the pixel according to the equation 1 or 3.

The generation method may further comprise, after the access S4 and before the application S6, demultiplexing the calibration information for each pixel. In other words, the second circuit 32 reads the calibration information and performs a demultiplexing of the information to transmit to the third circuit 33 the correction parameters PCi(Tj) at least at two distinct temperatures to perform an interpolation. When a correction table 20, 21 comprises calibration gains GPi, the demultiplexing comprises transmitting the calibration gains GPi to the fourth circuit 34 to calculate the value of the pixels according to the equation 2 or 3.

Advantageously, the sensor 1 may comprise a correspondence list for correlating the correction tables 20, 21 with at least one temperature value and, preferably, a temperature interval having two lower and upper bounds. For example, a temperature value may correspond to a correction table 20, 21. According to another example, a temperature interval may correspond to a correction table 20, 21. Advantageously, the correspondence list may further comprise, for each correction table 20, 21, a reference to the address of the correction table 20, 21 in the memory 6. The reference allows facilitating access S5 to the calibration information. Thus, the generation method may comprise recording in the memory 6, or in another distinct memory 7, the list of correspondence between the correction tables 20, 21 and the respective temperature values. The acquisition S4 may comprise reading a temperature TC of the sensor 1 and the access S5 comprises reading the calibration information contained in the correction table 20, 21 whose temperature value is equal to the temperature TC of the sensor 1, i.e. the temperature read before.

According to one implementation, several correction tables 20, 21 are recorded in the memory 6, and each correction table 20, 21 comprises correction parameters PCi(Tj) at two distinct temperatures, so-called minimum and maximum temperatures associated with the correction table 20, 21. In this case, the correspondence list comprises, for each correction table 20, 21, a correspondence with a temperature interval having as lower and upper bounds, respectively, the minimum and maximum temperatures associated with the correction table 20, 21. In this case, the access S5 comprises reading the calibration information contained in the correction table 20, 21 for which the temperature TC of the sensor 1 is comprised within the corresponding temperature interval of the correction table 20, 21.

The electronic control unit 30 may comprise a computer program comprising instructions for performing the steps of the method for determining calibration information as defined hereinbefore. The computer program may further comprise instructions for performing the steps of the method for generating images as defined hereinbefore.

1. A method for determining calibration information for an image sensor comprising a plurality of pixels, the method comprising:
obtaining at least two calibration tables associated with the image sensor, each calibration table containing, for each pixel, a piece of calibration information, the calibration information of the calibration table being organized into a series ordered according to a successive order of the pixels (OP),
wherein the method further comprises:
constructing at least one correction table for the image sensor, each correction table containing the calibration information of at least two calibration tables, the calibration information of the correction table is organized into a series ordered according to the successive order of the pixels.

2. The method according to claim 1, wherein the construction of each correction table comprises interleaving the calibration information of said at least two calibration tables so that the calibration information of the correction table is organized, for each pixel, according to a successive order of the calibration tables.

3. The method according to claim 1, wherein the calibration information of at least one calibration table, so-called calibration table at a specific temperature, comprises non-uniformity correction parameters of the image sensor at the specific temperature.

4. The method according to claim 3, wherein the obtainment comprises obtaining several calibration tables, so-called calibration tables at distinct specific temperatures, and the construction comprises constructing at least one correction table containing the calibration information of at least two calibration tables at distinct specific temperatures.

5. The method according to claim 3, wherein the obtainment comprises obtaining at least three calibration tables, so-called calibration tables at three distinct specific temperatures, and the construction comprises constructing at least one correction table containing the calibration information of said at least three calibration tables at distinct specific temperatures.

6. The method according to claim 4, wherein the obtainment comprises obtaining at least three calibration tables, so-called calibration tables at three distinct specific temperatures, and the construction comprises constructing a first correction table containing the calibration information of first and second calibration tables at two successive temperatures according to a first successive order of the calibration tables, and a second correction table containing the calibration information of the second calibration table and a third calibration table at a specific temperature successive to that of the second calibration table according to a second successive order of the calibration tables.

7. The method according to claim 1, wherein the calibration information of a calibration table, so-called gain table, comprises calibration gains.

8. The method according to claim 7, wherein the construction comprises constructing at least two correction tables, each correction table containing the calibration information of the gain table.

9. A method for generating images comprising a plurality of pixels, the method comprising:
recording in at least one memory of an image sensor at least one correction table for the image sensor constructed by the method according to claim 1;
successively acquiring, according to a successive order of the pixels, image frame data generated by the image sensor;
accessing said at least one memory comprising reading the calibration information contained in said at least one correction table; and
successively applying, according to the successive order of the pixels, the calibration information contained in said at least one correction table to the image frame data.

10. The method according to claim 9, wherein the successive acquisition is performed on-the-fly.

11. The method according to claim 9, wherein the reading the calibration information is performed on-the-fly.

12. The method according to claim 9, wherein the acquisition and the read-out are performed, for each pixel, synchronously.

13. The method according to claim 9, wherein said at least one correction table is constructed by a method for determining calibration information for an image sensor comprising a plurality of pixels, the method comprising:
obtaining at least two calibration tables associated with the image sensor, each calibration table containing, for each pixel, a piece of calibration information, the calibration information of the calibration table being organized into a series ordered according to a successive order of the pixels,
wherein the method further comprises:
constructing at least one correction table for the image sensor, each correction table containing the calibration information of at least two calibration tables, the calibration information of the correction table is organized into a series ordered according to the successive order of the pixels,
and wherein the calibration information of at least one calibration table, so-called calibration table at a specific temperature, comprises non-uniformity correction parameters of the image sensor at the specific temperature, and
wherein the obtainment comprises obtaining several calibration tables so-called calibration tables at distinct specific temperatures, and the construction comprises constructing at least one correction table containing the calibration information of at least two calibration tables at distinct specific temperatures, and
said at least one correction table comprises non-uniformity correction parameters of the image sensor at least at two distinct specific temperatures, the method comprising recording in said at least one memory a list of correspondence between said at least one correction table and at least one temperature interval having as lower and upper bounds respectively said at least two distinct specific temperatures, and wherein the acquisition comprises reading a temperature of the image sensor, and the accessing comprises reading the calibration information contained in the correction table for which the temperature of the image sensor is comprised within the corresponding temperature interval of the correction table.

14. The method according to claim 9, comprising, after the access and before the application, demultiplexing the calibration information for each pixel.

15. An image sensor comprising a plurality of pixels, the sensor comprising at least one memory containing at least one correction table for the image sensor, wherein said at least one correction table is constructed by the method for determining calibration information according to claim 1.

16. The sensor according to claim 15, further comprising a first memory comprising at least one correction table containing non-uniformity correction parameters of the image sensor at least at a specific temperature and a second memory comprising a gain table containing, for each pixel, calibration gains organized into a series ordered according to a successive order of the pixels.

17. The sensor according to claim 15, wherein said at least one memory is a non-volatile memory configured for read-only operation.

18. The sensor according to claim 15, further comprising an electronic control unit configured to implement a method for generating images comprising a plurality of pixels, the method comprising: recording in at least one memory of an image sensor at least one correction table for the image sensor constructed by constructing at least one correction table for the image sensor, each correction table containing the calibration information of at least two calibration tables, the calibration information of the correction table is organized into a series ordered according to the successive order of the pixels; successively acquiring, according to a successive order of the pixels, image frame data generated by the image sensor; accessing said at least one memory comprising reading the calibration information contained in said at least one correction table; and successively applying, according to the successive order of the pixels, the calibration information contained in said at least one correction table to the image frame data and wherein the electronic control unit comprises an FPGA-type programmable logic circuit.

19. (canceled)

20. A computer program product intended for determining calibration information, comprising instructions which, when executed by an electronic control unit, enable the electronic control unit to perform the steps of the method for determining calibration information according to claim 1.

21. A computer program product intended for generating images comprising a plurality of pixels, comprising instructions which, when executed by an electronic control unit, enable the electronic control unit to perform the steps of the method for generating images according to claim 9.
